(19) United States
(12) Patent Application Publication
(10) Pub. No.: US 2017/0278187 A1
(43) Pub. Date: Sep. 28, 2017

(54) Business Method for Trading Securities in Legal Entities

(71) Applicant: John Houvener, Everett, WA (US)

(72) Inventor: John Houvener, Everett, WA (US)

(21) Appl. No.: 15/468,051

(22) Filed: Mar. 23, 2017

Related U.S. Application Data
(60) Provisional application No. 62/311,914, filed on Mar. 23, 2016.

(51) Int. Cl. G06Q 40/04; G06Q 40/06

(52) U.S. Cl. CPC G06Q 40/04; G06Q 40/06; G06Q 50/18

(57) ABSTRACT

A business method for trading securities in legal entities by creating a legal investment company 100% owned by one or more attorneys that can then form partnerships with law firms and other legal entities. The legal investment company may offer investment vehicles to attorneys and non-attorneys. These investment vehicles may give the law firms the benefits enjoyed by non-lawyer professional organizations while following all applicable ethical guidelines.

### CROSS-REFERENCE TO RELATED APPLICATIONS

The present application is a nonprovisional application which claims the benefit of U.S. Provisional Patent Application No. 62/311,914, filed on Mar. 23, 2016, entitled “Business Method for Trading Securities in Legal Entities,” which is incorporated herein by reference in its entirety as if fully set forth herein.

### TECHNICAL FIELD

The current application relates to securities transactions and other financial instruments surrounding ownership of companies.

### BACKGROUND

Though attorneys are trained legal professionals, most are not trained business managers and so lack some basic skills those trained in business management take for granted. This can drive up legal costs by leading to inefficiently managed law firms. Doctor's offices and other professional businesses hire and empower managers to increase efficiency by giving them an ownership stake in the company. They can also spread risk and raise funds by selling stock on the open market. Ethical rules prevent lawyers from engaging in such activities. New York Professional Conduct rule 5.4, for example, prevents a lawyer from sharing any part of a legal fee with a non-lawyer or from entering into a partnership with a non-lawyer for the practice of law. All fifty bar associations in the U.S. have similar rules. This is not true in the rest of the world. The United Kingdom, for example, allows non-lawyers to have an ownership stake in law firms. New York Professional Conduct rule 5.4 and other rules like it have been challenged on constitutional grounds but no court has yet found the rules to be unconstitutional.

The ban on non-lawyer ownership of law firms has kept many promising law firms from forming due to lack of funding, kept many profitable law firms from going public and raising funds to expand, and kept the cost of legal services artificially high. For the foregoing reasons, a solution is needed that gives law firms the benefits enjoyed by other professional organizations but stays within the ethical guidelines.

Accordingly, a business method for trading securities in legal entities is disclosed.

### SUMMARY

The present invention creates a company 100% owned by attorneys that can then form partnerships with law firms and offer investment vehicles to attorneys and non-attorneys. These investment vehicles may give the law firms the benefits enjoyed by non-lawyer professional organizations while following all applicable ethical guidelines.

The following embodiments and descriptions are for illustrative purposes only and are not intended to limit the scope of the Business Method for Trading Securities in Legal Entities. Other aspects and advantages of the present disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 is a block diagram of an ownership chart showing who owns what in the business method.

FIG. 2 is a block diagram of an organizational chart showing lines of control according to the business method.

FIG. 3 is a flow diagram of one embodiment of the business method.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

The present disclosure is generally drawn, inter alia, to a business method for trading securities in legal entities. In the preferred embodiments, the business method comprises a legal investment company 100% owned by one or more attorneys that can then form partnerships with law firms and other legal entities in order offer investment vehicles to attorneys and non-attorneys.

A legal investment company (LIC) is a company that is wholly owned by one or more attorneys and may have contractual, equity, or partner relationships with a vast number of law firms throughout the country. These relationships between the LIC and the partner law firms would be one in which the amount of equity would be fluid based on the performance of the law firm and based on one or more private fund(s) (PF) or one or more private fund performance (PFP) indicator(s).

The LIC, for example, could own an option of purchasing up to 20% of a partnering company's equity, thus taking on 20% of the profits or losses of the firm.

The LIC would make its purchase or selling of equity in a law firm based on a multitude of factors including law changes, technology, and forces, such as the market, environmental, political, and economic. Moreover, decisions to purchase are based in majority by the performance of the law firm and its various practice areas—the LIC would conduct audits and evaluate the firms based on knowledge and experience in the fields of law to assess the health of the firm. For example, if after second quarter (Q2) numbers were released by a firm and the LIC wanted to purchase another 5% of the firm that the LIC already had a 10% equity interest in, the LIC would be able to negotiate with the law firm in order to acquire the additional equity.

The LIC is comprised of multiple funds, each with individual investment strategies. The funds may be divided up by region, state, city legal discipline investment risk, or any combination of the forgoing. For example, one specific fund might be Estate Planning in Seattle, Wash.—which might comprise only 5-10 actual law firms. Whereas investing in Estate Planning Pacific Northwest might comprise Oregon, Idaho and Washington and be made up of 20-30 different individual funds and between 100-150 actual law firms.

Therefore, the size (and dollar value) of each fund depends largely on the amount of private third party investment. However, which and how much the LIC should invest into each individual firm is left solely up to the autonomous legal opinion of the LIC.

The investors, therefore, do not directly contribute any funds directly to the law firms. Instead, they simply purchase a security interest via the LIC in a fund whose performance is commensurate with the profit/loss of a varying set of law firms.

Critically, non-lawyers would only own stock in the legal investment company (LIC). The legal investment company would own pieces of various law firms throughout the country and buy and sell these pieces based on legal and business considerations. Choosing to buy or sell the legal investment companies products would be the public's only means of influencing the legal investment companies' investment decisions. Much like mutual fund owners influence the purchasing decisions of mutual funds only by selling and buying shares of the mutual fund.

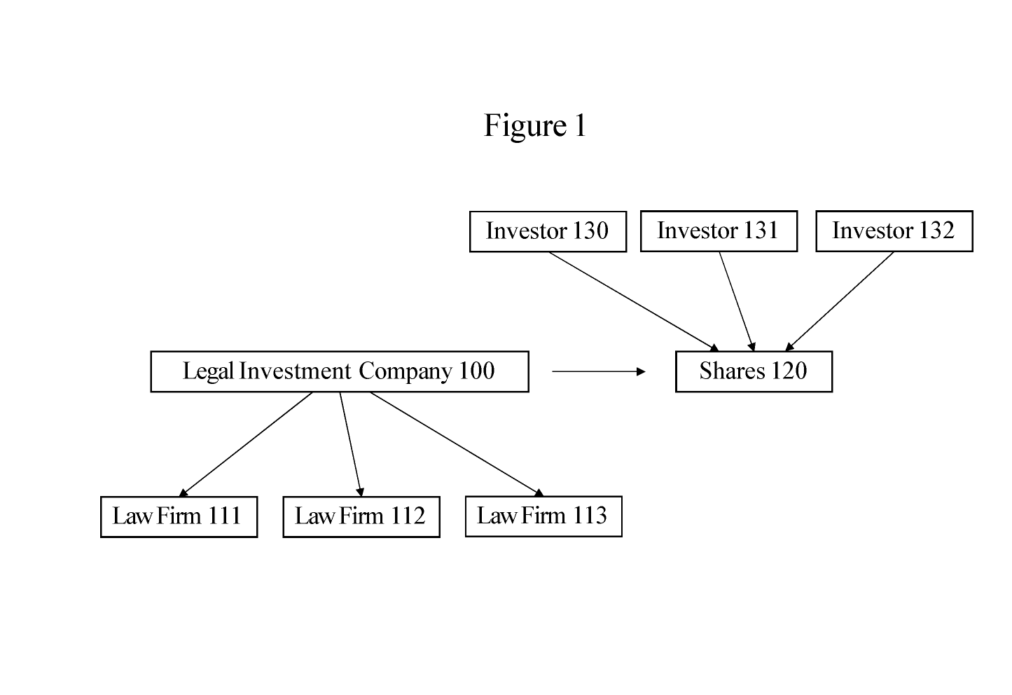

FIG. 1 is block diagram of an ownership chart showing who owns what in the business method, arranged in accordance with at least some embodiments of the present disclosure. FIG. 1 includes a legal investment company 100, a law firm 111, a law firm 112, a law firm 113, a shares 120, an investor 130, an investor 131, and investor 132. In FIG. 1, Legal Investment Company 100, also referred to as LIC 100, is an attorney-owned investment company that has made agreements with Law Firm 111, Law Firm 112, and Law Firm 113. Based on the agreements with Law Firm 111, Law Firm 112, and Law Firm 113, LIC 100 may determine share price and issue shares 120 within one or more investment funds. Shares 120 are of shares within investment funds of LIC 100 and do not involve direct ownership in Law Firm 111, Law Firm 112, and Law Firm 113. Investor 130, Investor 131, and Investor 132 may be attorney or non-attorney investors interested in purchasing Shares 120.

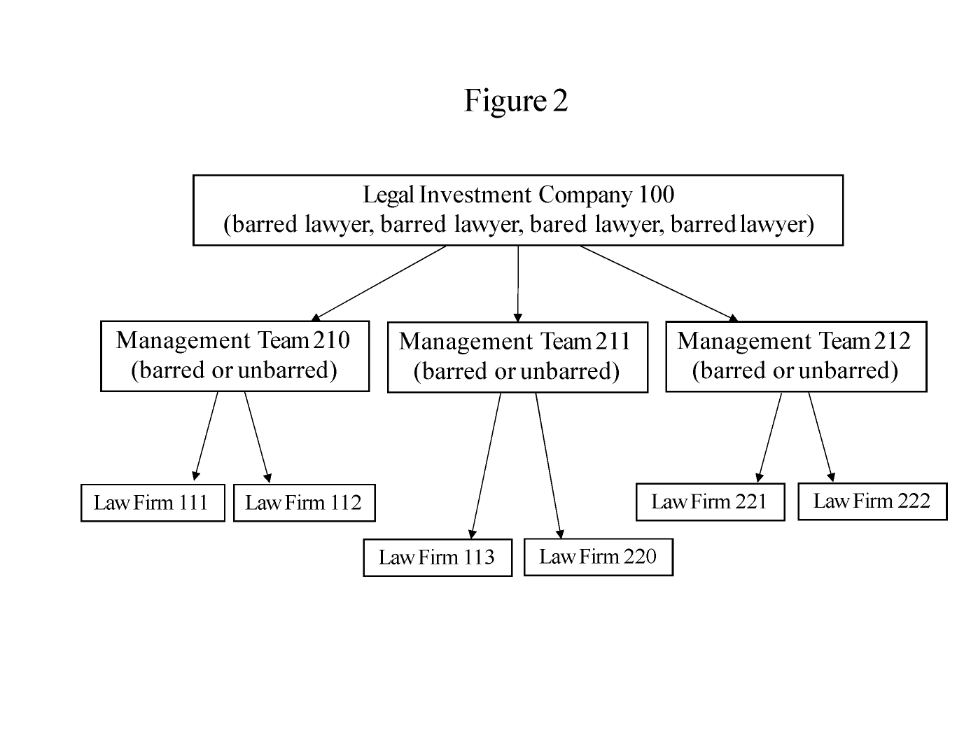

FIG. 2 is a block diagram of an organizational chart showing lines of control according to the business method, arranged in accordance with at least some embodiments of the present disclosure. FIG. 2 includes a legal investment company 100, a management team 210, a management team 211, a management team 212, a law firm 111, a law firm 112, a law firm 113, a law firm 220, a law firm 221, and a law firm 222. In FIG. 2, Legal Investment Company 100, also referred to as LIC 100, is an attorney-owned investment company that has management teams managing its affairs. Management Team 210 may comprise one or more barred attorneys in Washington State, one or more accountants, and one or more financial advisors. Management Team 210 would be responsible for managing the affairs involving Law Firm 111, Law Firm 112, and other law firms located in Washington State. Management Team 211 may comprise one or more barred attorneys in California State, one or more accountants, and one or more financial advisors. Management Team 211 would be responsible for managing the affairs involving Law Firm 113, Law Firm 220, and other law firms located in California State. Management Team 212 may comprise one or more barred attorneys in New York State, one or more accountants, and one or more financial advisors. Management Team 212 would be responsible for managing the affairs involving Law Firm 221, Law Firm 222, and other law firms located in New York State.

Critically, the management team are the only people in the organization that can be unbarred. Every other member of the organization has passed a bar of some sort. Just as critically, the management team has no ownership stake in either the law firms or the legal investment company. They are simply legal investment company employees.

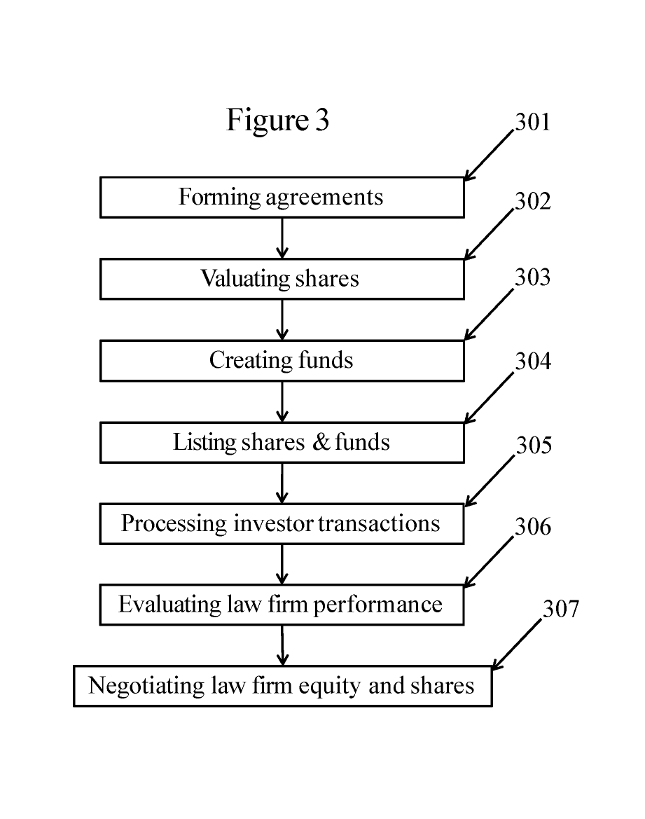

FIG. 3 is a flow diagram of one embodiment of the business method, arranged in accordance with at least some embodiments of the present disclosure. FIG. 3 includes a step 301, a step 302, a step 303, a step 304, a step 305, a step 306, and a step 307.

In FIG. 3, a flow diagram outlining the steps of the business method is displayed. In step 301, the LIC forms agreements for equity ownership with one or more law firms. In step 302, the LIC valuates shares of each of the law firms that have formed an agreement with the LIC. In step 303, the LIC creates one or more funds with investment strategies. Investment strategies may comprise location, firm type, and practice areas. In step 304, the LIC lists the shares of funds in one or more marketplaces. In step 305, the LIC processes investor purchase and sale transactions. Processing may comprise issuing securities certificates and tracking shareholders and shares sold. In step 306, the LIC evaluates performance of the law firms that have formed an agreement with the LIC. In step 307, the LIC negotiates amount of equity and shares of the law firms that have formed an agreement with the LIC. This step may be done when an agreement if first made and ongoing throughout the continuation of the agreement with a law firm.

In a preferred embodiment, the LIC includes lawyers barred in all jurisdictional entities and with backgrounds in every conceivable legal specialty. The state managers would then make partnership agreements with individual law firms as directed by the owners of the LIC. As a reminder, all of the owners of the LIC would be barred legal professionals. Periodically, the managers would perform audits of these law firms and rate them on values including but not limited to actual legal practice management, performance, and customer satisfaction. This data would then be used to develop a value representing prospective return on investment and investment risk level which would be used to help guide the LIC's investment decisions and rate the various funds from low risk to high risk.

While preferred and alternate embodiments have been illustrated and described, as noted above, many changes can be made without departing from the spirit and scope of the key organization apparatus and method. Accordingly, the scope of the key organization apparatus and method is not limited by the disclosure of these preferred and alternate embodiments. Instead, the scope of the key organization apparatus and method should be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. §112 ¶6. In particular, the use of “step of” in the claims herein is not intended to invoke the provisions of U.S.C. §112 ¶6.

What is claimed is:

1. A business method for providing a marketplace for a share of securities transactions surrounding ownership of legal entities, comprising:
forming, by one or more legal investment companies, agreements for equity ownership with one or more law firms;
valuating, by the legal investment company, shares of each of the law firms under an agreement;
forming, by the legal investment company, one or more funds associated with the performance of the shares of a plurality of law firms;
listing, by the legal investment company, shares of funds in one or more marketplaces;
processing, by the legal investment company, investor purchase and sale transactions;
evaluating, by the legal investment company, performance of the law firms under an agreement; and
negotiating, by the legal investment company, amount of equity and share of the law firms under an agreement.

2. The method of claim 1, wherein the agreements with each of the one or more law firms may have contractual, equity, or partner relationships.

3. The method of claim 1, wherein the agreements with each of the one or more law firms may include a provision that the amount of equity would be fluid based on the performance of the law firm.

4. The method of claim 1, wherein the valuation of the shares of each of the law firms under an agreement may be based on one or more private funds or one or more private fund performance indicators.

5. The method of claim 1, wherein the one or more funds with investment strategies may comprise city, state, regional, national, and international areas.

6. The method of claim 1, wherein the one or more funds with investment strategies may comprise one or more legal practice areas.

7. The method of claim 1, wherein the evaluation of the performance of each of the law firms under agreement may comprise audits and ratings in actual legal practice management, performance, and customer satisfaction.

8. An asset portfolio comprising:
an option to purchase or sell an ownership share of a law firm;
a plurality of options to purchase or sell an ownership share of a law firm in one or more areas of law;
one or more funds associated with the options to purchase or sell an ownership share of a law firm in one or more areas of law; and
shares of the funds in one or more marketplaces.
